(19) United States
(12) Patent Application Publication
(10) Pub. No.: US 2019/0363636 A1
(43) Pub. Date: Nov. 28, 2019

(54) DC/DC Converter with Full-Bridge Actuation

(71) Applicant: Siemens Aktiengesellschaft, München (DE)

(72) Inventors: Thomas Komma, Leipzig (DE); Mirjam Mantel, Haar (DE); Monika Poebl, München (DE)

(73) Assignee: Siemens Aktiengesellschaft, München (DE)

(21) Appl. No.: 16/485,201

(22) PCT Filed: Jan. 24, 2018
(86) PCT No.: PCT/EP2018/051687

§ 371 Date: Aug. 12, 2019

(30) Foreign Application Priority Data
Feb. 10, 2017 (DE) 10 2017 202 130.6

(51) Int. Cl. H02M 3/335

(52) U.S. Cl. CPC H02M 3/33592; H02M 3/33507

(57) ABSTRACT

A DC/DC converter comprising: a first half-bridge connected in parallel to a second half-bridge; a transformer having a primary side connected between respective center points of the first half-bridge and the second half-bridge; and a rectifier connected to a secondary side of the transformer. The first half-bridge and the second half-bridge each comprise a series circuit having switch arrangements. A first respective switch arrangement of each half-bridge is connected in front of the respective center point and a second respective switch arrangement is connected behind the respective center point. Each switch arrangement comprises two power-electronics switches. Each of the half-bridges includes a first capacitor circuit connected in parallel with a first of the switch arrangements and a second capacitor circuit connected in parallel with a second of the switch configurations. The capacitor circuits each comprise a capacitor. The power-electronics switches comprise IGBTs or MOSFETs.

### CROSS-REFERENCE TO RELATED APPLICATIONS

This application is a U.S. National Stage Application of International Application No. PCT/EP2018/051687 filed Jan. 24, 2018, which designates the United States of America, and claims priority to DE Application No. 10 2017 202 130.6 filed Feb. 10, 2017, the contents of which are hereby incorporated by reference in their entirety.

### TECHNICAL FIELD

The present disclosure relates to converters. Various embodiments may include DC/DC converters with full bridge actuation incorporating the phase-shift principle or the LLC principle.

### BACKGROUND

DC-voltage converters (DC/DC converters) with higher switching frequencies of more than 16 kHz and DC-link voltages above 600 V have hitherto not been easily implemented, because MOSFETS have not been available in the required voltage range. A series circuit formed of the power-electronics switches, such as IGBTs and MOSFETs, in order to increase the blocking voltage fails due to the fact that the switches cannot be switched at exactly the same time, and the reverse voltage of each individual switch is therefore exceeded when it switches off.

### SUMMARY

The teachings of the present disclosure describe a DC-voltage converter for a DC-link voltage of more than 600 V, in particular more than 1000 V. For example, various embodiments may include a DC/DC converter (20), designed to operate in accordance with the phase-shift principle or in accordance with the LLC principle, having a first and a second half-bridge (11, 12), which are connected in parallel, a transformer (13), the primary side of which is connected between the center points of the half-bridges (11, 12), a rectifier (14) in connection with the secondary side of the transformer (13), characterized in that the half-bridges (11, 12) each have a series circuit comprising switch arrangements (11A, 11B, 12A, 12B), one of which being connected in front of its center point and another being connected behind its center point, and each comprising at least two power-electronics switches (111 . . . 114, 121 . . . 124) and in both of the half-bridges (11, 12) a first capacitor circuit is connected in parallel with a first of the switch arrangements (11A, 11B, 12A, 12B) and a second capacitor circuit is connected in parallel with a second of the switch configurations (11A, 11B, 12A, 12B), wherein the capacitor circuits each comprise at least one capacitor (1110, 1111, 1210, 1211), the power-electronics switches (111 . . . 114, 121 . . . 124) are IGBTs or MOSFETs.

In some embodiments, the switch arrangements (11A, 11B, 12A, 12B) each comprise at least three power-electronics switches (111 . . . 114, 121 . . . 124).

In some embodiments, at least one of the capacitor circuits for each power-electronics switch (111 . . . 114, 121 . . . 124) of the switch arrangement (11A, 11B, 12A, 12B) associated therewith has a capacitor (1110, 1111, 1210, 1211), wherein the capacitors (1110, 1111, 1210, 1211) are connected in series and each of the capacitors (1110, 1111, 1210, 1211) is connected in parallel with a respective power-electronics switch (111 . . . 114, 121 . . . 124).

In some embodiments, the power-electronics switches (111 . . . 114, 121 . . . 124) are ones with a maximum reverse voltage of less than 1000 V.

In some embodiments, the power-electronics switches (111 . . . 114, 121 . . . 124) are of the same type.

In some embodiments, the converter may be designed for an input voltage of more than 700 V.

In some embodiments, the capacitors (1110, 1111, 1210, 1211) have capacitances between 100 pF and 2000 pF.

### BRIEF DESCRIPTION OF THE DRAWINGS

An exemplary embodiment of the teachings herein, but one which is in no way restrictive of the scope of the disclosure, is explained below on the basis of the figures of the drawing. The features are shown in schematic form. Shown are:

FIG. 1: a block diagram of a first DC/DC converter with capacitors for both half-bridges, incorporating teachings of the present disclosure; and

FIG. 2: a half-bridge of a second DC/DC converter with capacitors for each switch incorporating teachings of the present disclosure.

### DETAILED DESCRIPTION

In some embodiments of the present teaching, a DC/DC converter with full bridge actuation comprises a first and a second half-bridge which are connected in parallel, in addition to a transformer whose primary side is connected between the center points of the half-bridges, and a rectifier in connection with the secondary side of the transformer. In some embodiments, the half-bridges in the DC/DC converter also each have a series circuit consisting of one switch arrangement connected in front of its center point and one switch arrangement connected behind its center point, each switch arrangement consisting of at least two power-electronics switches.

In some embodiments, in both of the half-bridges a first capacitor circuit is connected in parallel with a first of the switch arrangements and a second capacitor circuit is connected in parallel with a second of the switch arrangements. The capacitor circuits each comprise at least one capacitor. Finally, the power-electronics switches are IGBTs (Isolated Gate Bipolar Transistor), preferably with integrated free-wheeling diodes, or MOSFETs (Metal Oxide Semiconductor Field-Effect Transistor).

In some embodiments, the DC/DC converter is designed to perform an actuation of the power-electronics switches in accordance with the phase-shift principle or else in accordance with the LLC principle. The DC/DC converter therefore uses two power-electronics switches connected in series in each of its half-bridges, in order to increase the possible DC-link voltage. The normally destructive increase in the voltage across the switch that responds later during a turn-off operation is delayed by parallel connected capacitors, the capacitors being separate components, i.e., they are present in addition to a parasitic capacitance of the power-electronics switches. As a result, the later of the two switches also turns off at the correct time, i.e. before the applied voltage has exceeded its maximum reverse voltage.

In this manner, DC/DC converters can be constructed with DC-link voltages above 600 V, in particular above 1000 V, wherein individual power-electronics switches with reverse voltages of less than 1000 V are used. These DC/DC converters also allow the use of high switching frequencies of greater than 16 kHz, for example greater than 50 kHz, in particular at least 100 kHz.

Of these, the embodiment described above can be combined with the features of the various following embodiments, or also with those of multiple embodiments. Accordingly, the following features are additionally provided for the power converter:
At least one of the capacitor circuits can comprise a further capacitor in series with the capacitor. In this case the two potential points in the capacitor circuit, which are formed between the additional capacitor and the capacitor as well as between the power-electronics switches of the switch arrangement connected in parallel with the capacitor circuit, are electrically connected. In other words, the two capacitors are connected in series and at the same time, individually connected in parallel with a respective power-electronics switch.
The switch arrangements can each comprise at least three power-electronics switches. In further embodiments, the switch arrangements can also comprise four or five power-electronics switches each. This allows even higher input voltages of the DC/DC converter to be achieved.
Even if there are more than two switches per switch arrangement, at least one of the capacitor circuits for each power-electronics switch of the switch arrangement associated with it can have a capacitor, the capacitors being connected in series and each of the capacitors being connected in parallel with a respective power-electronics switch.
The first and/or second capacitor circuit for one or both of the half-bridges can comprise an additional capacitor in series with the capacitor, wherein in capacitor circuits with an additional capacitor the two potential points that are formed between the capacitors and between the power-electronics switches of the switch arrangement in parallel with the capacitor circuit, are electrically connected. In other words, a separate capacitor is present for each switch. The individual capacitors are therefore much smaller, and even if the number of capacitors is doubled the overall space required is reduced.
The power-electronics switches can be ones with a maximum reverse voltage of less than 1000 V. A DC/DC converter is thus created which is designed for a DC-link voltage of, for example, more than 1000 V, but in which only power-electronics switches with a maximum reverse voltage of, for example, 650 V are used.
The power-electronics switches can be of the same type. In other words, only MOSFETs or only IGBTs are used in the DC/DC converter.
The capacitors may have capacitances of between 100 pF and 2000 pF.

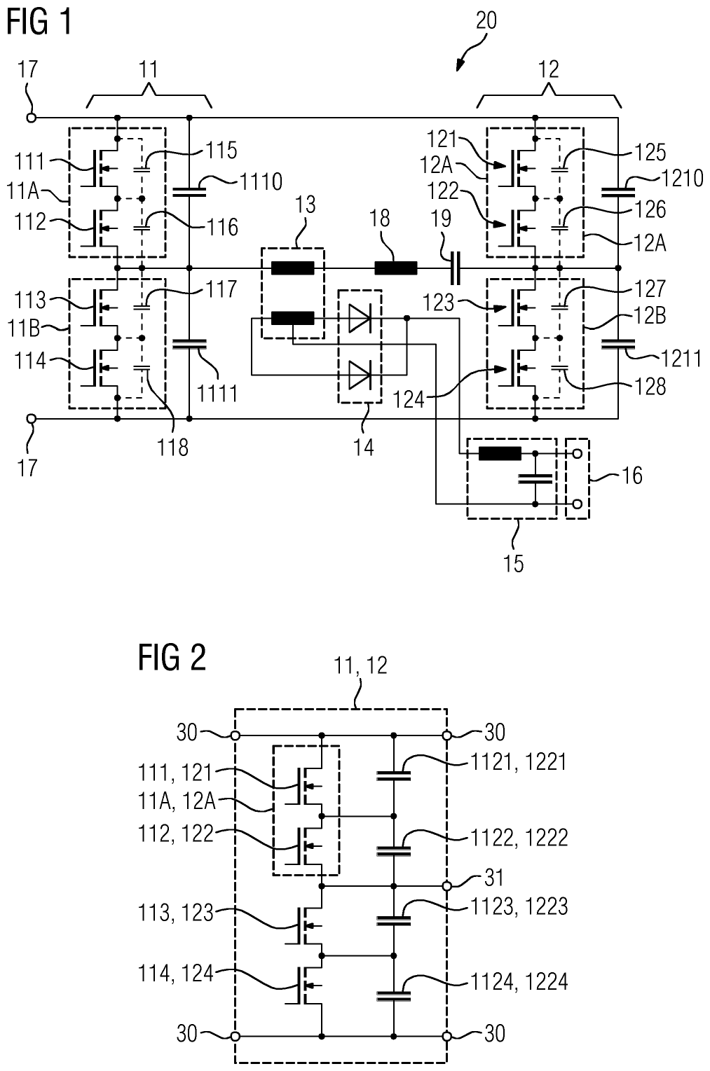

FIG. 1 shows a first DC/DC converter 10, which comprises a resonant DC/DC converter with full bridge actuation. In connection to two input terminals 17, two half-bridges 11, 12 are connected in parallel. The primary side of a transformer 13 is connected between the center points of the two half-bridges 11, 12, and a resonance inductor 18 and a series capacitor 20161357719 for transferring a DC component are connected in series with the primary side. The secondary side thereof is in turn connected in a center-point circuit to output terminals 16 via a rectifier circuit 14, here realized as two diodes. A filter element 15 for smoothing the output voltage with a serial inductance and parallel capacitance is connected between rectifier 14 and output terminals 16.

The converter shown in FIG. 1 is designed as a type of DC/DC converter actuated and operated in accordance with the phase-shift principle. In some embodiments, the series capacitor 19 can be omitted. If the converter is to be operated in accordance with the LLC principle, then the inductance in the filter element 15 is typically omitted, while the series capacitor 19 is used as a resonance capacitor.

The first half-bridge 11 has two switch arrangements 11A, 11B connected in series, between which the center point of the half-bridge is located. In contrast to known DC/DC converters each of the switch arrangements 11A, 11B comprises at least two, or exactly two, power-electronics switches 111 . . . 114 which are connected in series. In the present example these are MOSFETs. In alternative embodiments, however, they can also be IGBTs. The same type of switch may be used for the entire DC/DC converter 10.

The second half-bridge 12 also has two switch arrangements 12A, 12B connected in series, between which the center point of the half-bridge and thus the terminal of the transformer 13 is situated. In contrast to known DC/DC converters each of the switch arrangements 12A, 12B comprises at least two, or exactly two, power-electronics switches 121 . . . 124 that are connected in series. In this example, these are also MOSFETs. In alternative embodiments, however, they can also be IGBTs.

The second half-bridge 12 as shown also comprises a first capacitor 1210 in parallel with the first switch arrangement 12A. In parallel with the second switch arrangement 12B, a second capacitor 1211 is connected. The first and second capacitor are, for example, ceramic or film capacitors with a capacitance of, for example, 100 pF, wherein in other embodiments capacitances of 500 pF, 100 pF or other capacitances between 50 pF and 2 nF can be chosen.

The circuit arrangements 11A, 11B of the first half-bridge 11 have a parallel-connected third and fourth capacitor 1110, 1111. The third and fourth capacitors in this example are designed in the same way as the first and second capacitor.

During continuous operation, the capacitors 1210, 1211 ensure that the speed of the voltage increase is limited when turning off one of the circuit arrangements. Differences in the exact time at which the two switches 121 . . . 124 of one of the switch arrangements 12A, 12B are turned off are inevitable. Without the capacitors 1210, 1211, however, they would cause one of the switches 121 . . . 124 to block the total DC-link voltage, resulting in damage to the switch 121 . . . 124. The voltage rise delayed by the capacitors 1210, 1211, however, gives the switches 121 . . . 124 enough time to turn off and to split the voltage to be blocked over both switches 121 . . . 124.

FIG. 1 also shows, in addition to the switches 121 . . . 124, the unavoidable parasitic capacities 125 . . . 128 contained in them. This is intended to illustrate that the capacitors 1210, 1211 are added components, which are not the same as the parasitic capacitances 125 . . . 128. The capacitance of the capacitors 1210, 1211 is in the range of the parasitic capacitances 125 . . . 128 or greater, which causes the voltage rise to be further delayed than by the parasitic capacitances 125 . . . 128 alone.

In some embodiments, the DC/DC converter 10 therefore has two identically designed half-bridges 11, 12. A control device not shown in FIG. 1 may actuate the switches 111 . . . 115, 121 . . . 125 to enable operation of the circuit as a DC/DC converter. For this purpose, the switch arrangements for the resonant or quasi-resonant operation may be actuated in accordance with a phase-shift type or in accordance with an LLC converter type.

In the phase shift-principle, the on and off switching times of the diagonally opposite circuit arrangements are temporally offset relative to each other, resulting in a quasi-resonant operation. This arrangement takes account of the recharging time that results from the capacitances and inductances present when a circuit arrangement 11A, 11B, 12A, 12B is turned off. The recharging times must now allow for the added capacitors 1121, 1221, 1122, 1222 in the design of the actuation for the switches 111 . . . 114, 121 . . . 124. The control device may be therefore designed to apply a dead time for actuating the switches 111 . . . 114, 121 . . . 124, which is adapted to match the resonance inductor and load current that results from the use of the capacitors 1121, 1221, 1122, 1222 compared to a DC/DC converter without these capacitors and with only one switch per switch arrangement.

In an alternative design, which is practical especially in the case of the phase-shift principle, the third and fourth capacitor 1110, 1111 have a smaller capacitance than the first and second capacitor. When one of the switch arrangements 12A, 12B of the second half-bridge 12 is turned off, the discharge of the respective first or second capacitor 1210, 1211 takes place by utilizing the additional energy of the smoothing inductor in the filter element 15. During the discharge of the third or fourth capacitor 1110, 1111, on the other hand, only the energy of the resonance inductor 18 is used, which means that a smaller quantity of charge can be transported in the same period of time. Thus a smaller capacitance is better suited to a quasi-resonant operating mode with a fixed switching frequency and dead time.

FIG. 2 shows a half-bridge 11, 12 for a DC/DC converter according to a third exemplary embodiment of the teachings herein. For the sake of better clarity, FIG. 2 shows only the half-bridge 11, 12, which can be used in the otherwise unchanged DC/DC converter in accordance with the first or second exemplary embodiment described above. One or both of the half-bridges 11, 12 of the DC/DC converter can be designed according to FIG. 2.

The terminals 30 shown in FIG. 2 are used for integration into the DC-link, thus the input voltage of the DC/DC converter 10, 20. The additional terminal 31 is used for the connection to the primary side of the transformer 13. The terminals 30, 31 are typically only symbolic and do not necessarily have any physical counterpart in the assembled DC/DC converter 10, 20.

In the half-bridge in accordance with FIG. 2 the first and third capacitor 1110, 1210 are replaced by a series connection of two capacitors 1121, 1221, 1122, 1222. In addition, a direct electrical connection exists between the potential point between these capacitors 1121, 1221, 1122, 1222 and the potential point between the switches 111, 121, 112, 122 of the first circuit arrangement 11A, 12A of the relevant half-bridge 11, 12.

Equally, in the half-bridge in accordance with FIG. 2 the second and fourth capacitor 1111, 1211 are replaced by a series connection of two capacitors 1123, 1223, 1124, 1224. In addition, a direct electrical connection exists between the potential point between these capacitors 1123, 1223, 1124, 1224 and the potential point between the switches 113, 123, 114, 124 of the first circuit arrangement 11B, 12B of the relevant half-bridge 11, 12.

What is claimed is:

1. A DC/DC converter using the phase-shift principle or the LLC principle, the converter comprising:
a first half-bridge connected in parallel to a second half-bridge;
a transformer having a primary side connected between respective center points of the first half-bridge and the second half-bridge;
a rectifier connected to a secondary side of the transformer;
wherein the first half-bridge and the second half-bridge each comprise a series circuit having switch arrangements;
wherein a first respective switch arrangement of each half-bridge is connected in front of the respective center point and a second respective switch arrangement is connected behind the respective center point;
wherein each switch arrangement comprises two power-electronics switches;
wherein each of the half-bridges includes a first capacitor circuit connected in parallel with a first of the switch arrangements and a second capacitor circuit connected in parallel with a second of the switch configurations;
wherein the capacitor circuits each comprise a capacitor; and
wherein the power-electronics switches comprise IGBTs or MOSFETs.

2. The DC/DC converter as claimed in claim 1, wherein the switch arrangements each comprise three power-electronics switches.

3. The DC/DC converter as claimed in claim 1, wherein:
at least one of the capacitor circuits for each power-electronics switch includes a capacitor;
the capacitors are connected in series to one another; and
each of the capacitors is connected in parallel with a respective power-electronics switch.

4. The DC/DC converter as claimed in claim 1, wherein the power-electronics switches each have a maximum reverse voltage of less than 1000 V.

5. The DC/DC converter as claimed in claim 1, wherein the power-electronics switches are each of a single type.

6. The DC/DC converter as claimed in claim 1, wherein the converter is rated for an input voltage of more than 700 V.

7. The DC/DC converter as claimed in claim 1, wherein the capacitors each have capacitances between 100 pF and 2000 pF.
